(19) United States
(12) Patent Application Publication
(10) Pub. No.: US 2009/0230969 A1
(43) Pub. Date: Sep. 17, 2009

(54) Downhole Acoustic Receiver with Canceling Element

(76) Inventors: David R. Hall, Provo, UT (US); Paula Turner, Pleasant Grove, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/473,416

(22) Filed: May 28, 2009

Related U.S. Application Data
(63) Continuation-in-part of application No. 12/341,771, filed on Dec. 22, 2008.
Application No. 12/341,771 is a continuation-in-part of application No. 11/776,447, filed on Jul. 11, 2007.
Application No. 11/776,447 is a continuation-in-part of application No. 11/676,494, filed on Feb. 19, 2007, now Pat. No. 7,265,649.
Application No. 11/676,494 is a continuation-in-part of application No. 11/687,891, filed on Mar. 19, 2007, now Pat. No. 7,301,429.
(60) Provisional application No. 60/914,619, filed on Apr. 27, 2007.
(60) Provisional application No. 61/073,190, filed on Jun. 17, 2008.

(51) Int. Cl. G01V 3/18

(52) U.S. Cl. 324/343

(57) ABSTRACT

A downhole tool string assembly comprising at least one transmitter. The transmitter may be a sonic transmitter, a seismic transmitter, or an ultrasonic transmitter. The transmitter may transmit an acoustic wave into an earthen formation. The speed of the wave as it travels through the formation or as it reflects off of objects and/or layers in the formation may reveal information about the formation. The downhole tool string assembly also comprises at least one receiver. The receiver is adapted to measure waves within the formation. The downhole tool string assembly also comprises at least one transducer proximate the receiver. The transducer is adapted to substantially cancel waves traveling along the borehole and/or tool string and allow the receiver to focus on the waves traveling through the formation.

### CROSS REFERENCE TO RELATED APPLICATIONS

This application is a continuation-in-part of U.S. patent application Ser. No. 12/341,771 filed on Dec. 22, 2008, which is a continuation-in-part of U.S. patent application Ser. No. 11/776,447 filed on Jul. 11, 2007 which claims priority to Provisional U.S. Patent Application No. 60/914,619 filed on Apr. 27, 2007 and entitled “Resistivity Tool.” This application is also a continuation-in-part of U.S. patent application Ser. Nos. 11/676,494; 11/687,891; 61/073,190. All of the above mentioned references are herein incorporated by reference for all that they contain.

### BACKGROUND OF THE INVENTION

The present invention relates to the field of downhole oil, gas and/or geothermal exploration and more particularly to the fields of acoustic tools for tool strings employed in such exploration.

Engineers in the oil, gas, and geothermal fields have worked to develop machinery and methods to effectively obtain information about downhole formations, especially during the process of drilling. Logging-while-drilling (LWD) refers to a set of processes commonly used in the art to obtain information about a formation during the drilling process. Such information may be used by downhole tool string components or be transmitted to the earth's surface.

Information regarding acoustic characteristics of a formation may be valuable to a drilling operation. Acoustic characteristics of a formation may include the speed of sound as it travels through varying subsurface formations or the location of objects or interfaces from which sound waves may rebound.

In acoustic systems, waves may be generated by a transmitter. Acoustic tools may be classified as sonic, seismic, or other designations depending on the frequency of the waves. This transmitter may comprise a hammer, an explosive element, a siren, a jar, a piezoelectric source, a magnetostrictive element, an eccentric rotor, a drill bit, or other means known in the art. This transmitter may be on the surface or may be located downhole. This transmitter generates an elastic wave which may propagate through an earthen formation. This elastic wave may interact with layers or other objects within the formation.

A receiver is then used to measure the wave at a different location and also to measure any incident waves that may have formed. A receiver is generally in the form of a geophone, a hydrophone, or an accelerometer. A geophone may comprise a magnetic mass moving within a wire coil to generate an electrical signal. A hydrophone may comprise a piezoelectric transducer that generates electricity when subjected to a pressure change. An accelerometer may comprise a cantilever beam with a proof mass that deflects in the presence of non-gravitational accelerations.

One difficulty with this method commonly arises when the transmitted wave makes contact with the borehole. This may create a tube wave that may travel along the borehole with less attenuation than the wave traveling through the earthen formation. Another difficulty may arise when the tool string makes contact with the borehole and the transmitted wave begins to travel in the form of an acoustic wave along the length of the tool string. An acoustic wave traveling through the metal of the tool string will generally travel at a much higher rate of speed than a wave traveling through the formation.

Some have attempted to reduce this problem by creating a tortuous path along the tool string for the waves to travel between the transmitter and receiver. This may cause the waves traveling along the tool string to significantly attenuate or to arrive so late that they may be readily recognized. However, the waves traveling along the tool string do still arrive and may still interfere depending on the length of time required for a reflected wave of interest to arrive at the sensor. Others have attempted to insert a dampening layer such as a fluid or gel at certain locations along the tool string to dampen the wave.

The prior art contains references to drill bits comprising acoustic transmitters and receivers. U.S. Pat. No. 7,334,661 to Pabon, et al., which is herein incorporated by reference for all that it contains, discloses an acoustic logging tool sleeve with a preferably discontinuous, alternating structure that is acoustically opaque in some zones, and acoustically transparent in others. The sleeve may be modular, with several stages connected together. The multiple stages provide a sleeve that may be useful with a variety of borehole logging tools to reduce or eliminate the transmission of noise to the receiving elements.

U.S. Pat. No. 7,032,707 to Egerev, et al., which is herein incorporated by reference for all that it contains, discloses a plurality of heavy mass irregularities attached to an inner wall of a drill collar to attenuate waves traveling through the collar. The plurality of heavy mass irregularities are spaced and sized for the maximum attenuation of acoustic pulses in a predetermined frequency range. The pipe may be of a soft material such as rubber to reduce transfer of acoustic noise along the drill string. In another embodiment of the invention, each of the mass irregularities is attached to the drill collar over substantially the entire length of the mass irregularity, enabling the attenuation of high frequencies. In yet another embodiment of the invention, the attenuator comprises a substantially cylindrical body with a plurality of recesses on the inside and/or outside of the cylindrical body, with the length of the recesses selected to provide attenuation within a specified band. In another embodiment of the invention, the attenuator comprises a plurality of sections each having an inner diameter and an outer diameter, each section acting like a waveguide with an associated passband and reject-band.

U.S. Pat. No. 6,082,484 to Molz, et al., which is herein incorporated by reference for all that it contains, discloses an acoustic attenuator that suppresses acoustic signals traveling along the body of a measurement-while-drilling (MWD) tool, making it possible to obtain acoustic measurements relating to underground formations. Shaped cavities (spherical or cylindrical) filled with a fluid have a resonance frequency that is tuned to be within the band of interest thereby attenuating acoustic signals traveling through the body at these resonance frequencies. The staggered arrangement of the cavities increases the path length for the acoustic signals and provides further attenuation. Attenuation may also be accomplished by use of a composite consisting of cylindrical layers of two different materials with thicknesses that attenuate selected frequencies. Additional attenuation is provided by lengthening the path length of a seismic signal passing through the more competent of the two materials of the composite.

### BRIEF SUMMARY OF THE INVENTION

A downhole tool string assembly may comprise an acoustic transmitter. In various embodiments, the transmitter may be a sonic transmitter, a seismic transmitter, an ultrasonic transmitter or other acoustic transmitter known in the art. The transmitter may comprise a hammer, an explosive element, a siren, a jar, a piezoelectric source, a magnetostrictive element, an eccentric rotor, or a drill bit. The transmitter may form part of a downhole tool string component, or may be a surface element. The transmitter may be adapted to generate an acoustic wave capable of traveling through an earthen formation and reflecting off or interacting with layers and other objects that may be located within the formation. The transmitter may be powered by a downhole battery, turbine, a power transmission system or combinations thereof. The transmitter may produce a characteristic wave such that the characteristic wave may be differentiated from noise generated by the primary downhole tool string.

At least one acoustic receiver adapted to measure acoustic waves within the formation may be disposed on the tool string and spaced apart from the transmitter. The receiver may be disposed on the same tool string as the transmitter or may be disposed on a separate tool string in a separate borehole. In various embodiments, the receiver may comprise a geophone, a hydrophone, or an accelerometer. A plurality of receivers may be oriented orthogonal each other and spaced circumferentially around the tool string. The plurality of receivers may also be spaced evenly and axially along the tool string.

At least one acoustic transducer adapted to create a canceling acoustic wave may be disposed on the tool string proximate the receiver and attached to a canceling signal generator. The acoustic transducer may comprise a piezoelectric crystal or magnetic coil device capable of creating an acoustic wave. The acoustic wave created by the transducer may be capable of canceling an acoustic wave traveling along the borehole or along the tool string as experienced at the receiver. This canceling may allow the receiver to measure less of a wave traveling along the borehole or tool string and more of a wave traveling through the formation. A downhole telemetry network may actuate or control the acoustic transducer via the canceling signal generator. The downhole telemetry network may comprise inductive couplers located in joints comprised within the tool string.

### BRIEF DESCRIPTION OF THE DRAWINGS

FIG. 1 is a side-view diagram of an embodiment of a downhole tool string assembly.

FIG. 2 is a side-view diagram of an embodiment of two downhole tool string assemblies.

FIG. 3 is a side-view diagram of another embodiment of a downhole tool string assembly.

FIG. 4 is a side-view diagram of another embodiment of a downhole tool string assembly.

FIG. 5 is a perspective diagram of an embodiment of a plurality of receivers integrated into a tool string component.

FIG. 6 is a cross-sectional diagram of an embodiment of a receiver integrated into a stabilizer blade.

FIG. 7 is an axial cross-sectional diagram of an embodiment of a receiver integrated into a stabilizer blade.

FIG. 8a is a cross-sectional diagram of a close-up view of embodiments of a receiver and transducer.

FIG. 8b is a perspective diagram of embodiments of a receiver and transducer.

FIG. 8c is another perspective diagram of embodiments of a receiver and transducer.

FIG. 8d is another perspective diagram of embodiments of a receiver and transducer.

### DETAILED DESCRIPTION OF THE INVENTION AND THE PREFERRED EMBODIMENT

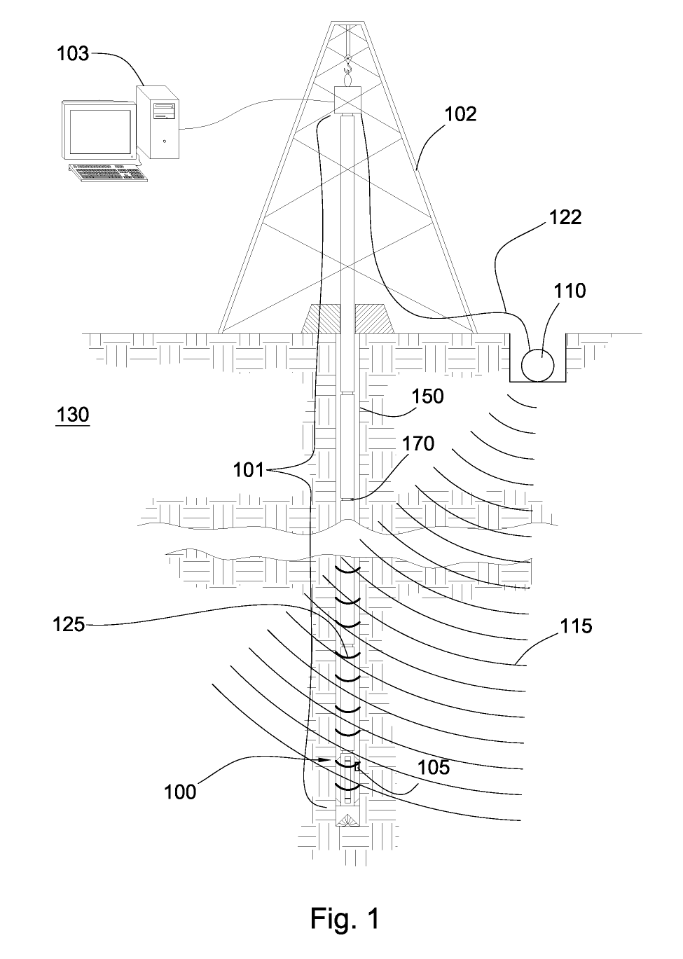

Referring to FIG. 1, a downhole tool string 101 is shown suspended by a derrick 102 in a borehole 150. A tool string component 100 is shown as part of the tool string 101 and may be in communication with surface equipment 103 through a downhole telemetry network 122. The downhole telemetry network 122 may comprise inductive couplers located in joints 170 of the tool string. The tool string component 100 comprises a receiver 105. The receiver 105 may comprise a geophone, a hydrophone, or an accelerometer. The receiver 105 may be adapted to measure waves within the surrounding earthen formation 130. Based upon the frequency of those waves, they may be referred to as sonic waves, ultrasonic waves, seismic waves or other designations known in the art.

A transmitter 110 is shown that may be adapted to generate waves in the earthen formation 130. In the embodiment shown, the transmitter is located on the surface of the formation 130. The transmitter 110 may comprise a hammer, an explosive element, seismic source, a siren, a jar, a piezoelectric source, a magnetostrictive element, an eccentric rotor, a drill bit, or any other device known in the art capable of propagating a wave through an earthen formation 130. The transmitter 110 may generate a wave 115 which travels through the earthen formation 130 and may be measured by the receiver 105 at the tool string component 100. The transmitter 110 and receiver 105 may be actuated or controlled by a downhole telemetry network 122.

If the wave 115 hits the borehole 150 a tube wave or acoustic wave 125 may be formed. A tube wave is a wave that may travel along the length of the borehole 150 and be measured by the receiver 105. The tube wave may propagate along the borehole 150 with a wavelength much longer than the diameter of the borehole 150. The tube wave may have less attenuation than the wave 115 traveling through the earthen formation 130. If the tool string 101 makes contact with the borehole 150, an acoustic wave may begin to travel along the length of the tool string 101. The acoustic wave traveling through the metal of the tool string 101 will generally travel at a much higher rate of speed than the wave 115 traveling through the earthen formation 130. Thus, the tube wave or acoustic wave 125 may interfere with the receiver's 105 ability to measure the wave 115.

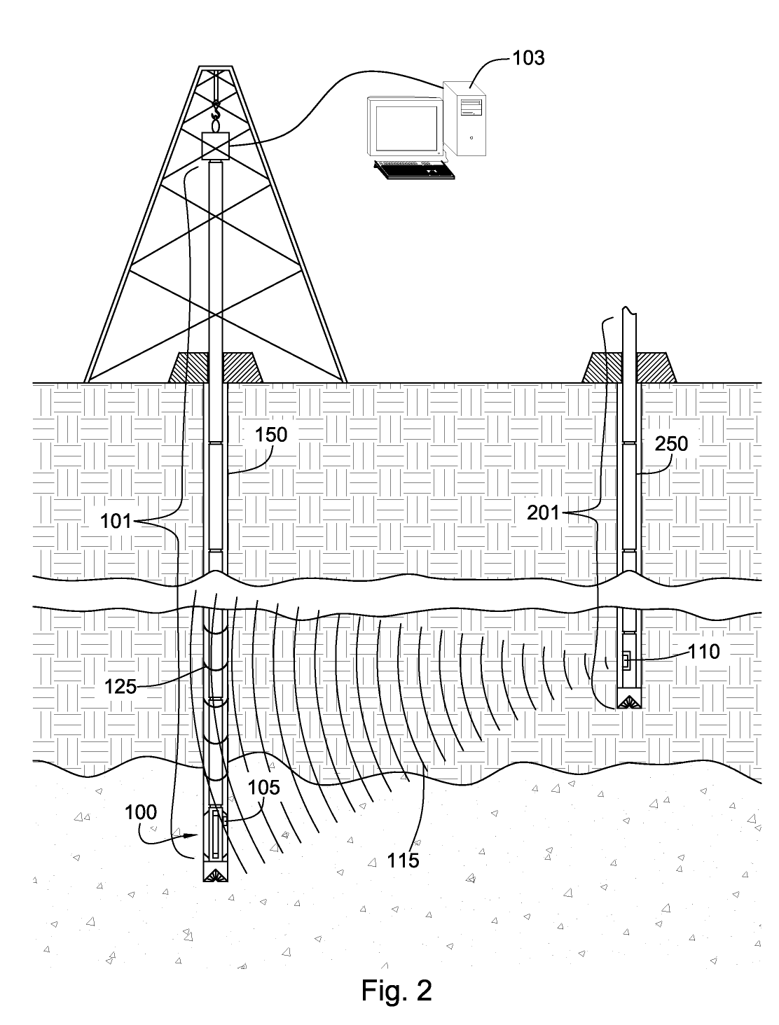

FIG. 2 depicts another embodiment where the transmitter 110 is located on a second tool string 201 suspended in a second borehole 250. In this embodiment, the transmitter 110 is shown generating a wave 115 which travels from the second borehole 250 through the earthen formation to the first borehole 150 where it is measured by the receiver 105. The wave 115 may create a tube wave or acoustic wave 125 when it comes in contact with the borehole 150 that may travel along the borehole 150 if a tube wave or along the tool string 101 if an acoustic wave and cause interference at the receiver 105.

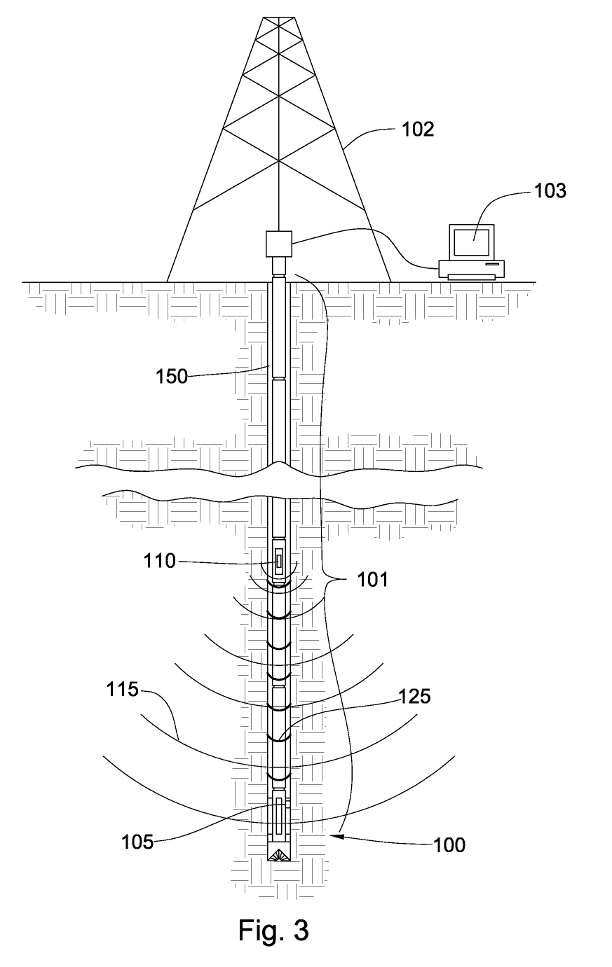

FIG. 3 depicts another embodiment where the transmitter 110 is located on the same tool string 101 as the receiver 105. In this embodiment, the transmitter 110 is shown generating waves 115 that may travel along the sides of the borehole 150 and be measured by the receiver 105. A tube wave or acoustic wave 125 may also be generated that may travel along the borehole 150 if a tube wave or along the tool string 101 if an acoustic wave and may cause interference at the receiver 105.

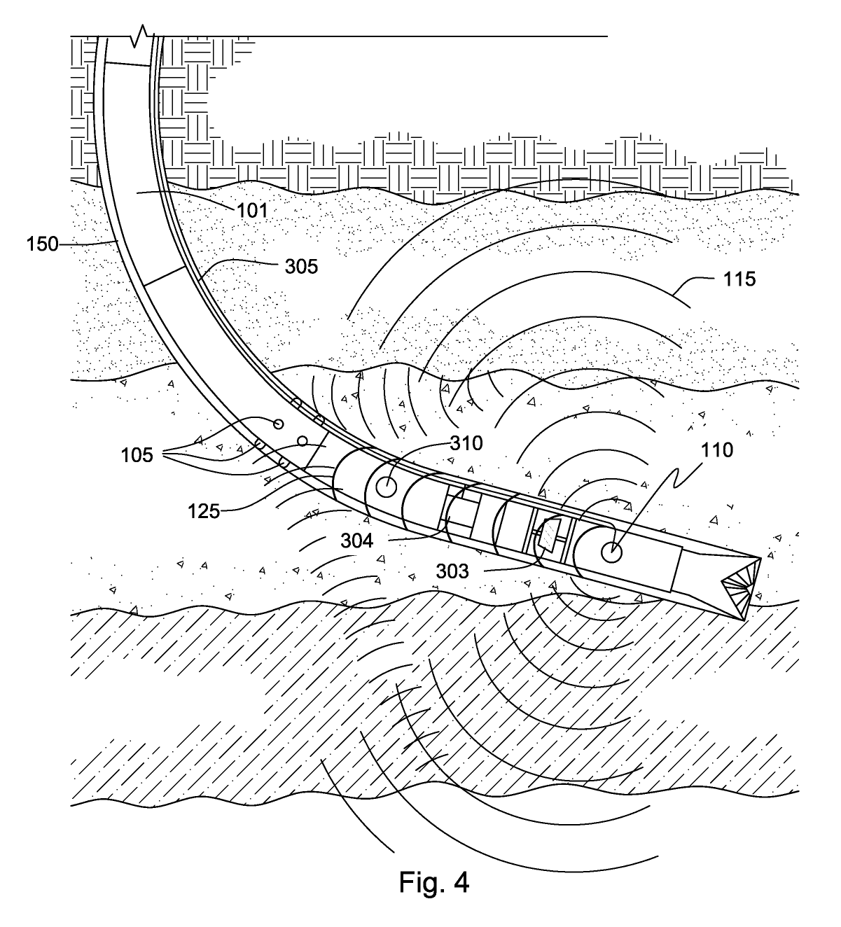

FIG. 4 depicts another embodiment where the transmitter 110 is located on the same tool string 101 as the receiver 105. In this embodiment, the transmitter 110 is shown generating waves 115 which may reflect off of various boundary layers and other objects within the earthen formation and then be measured by a plurality of receivers 105. The various receivers 105 may be orientated in different directions to measure different aspects of the wave 115. A tube wave or acoustic wave 125 may also be created which may travel along the borehole 150 if a tube wave or along the tool string 101 if an acoustic wave and cause interference at the receivers 105. The tube wave or acoustic wave 125 may be read by a sensor 310. It is believed that the tube wave or acoustic wave 125 as read by the sensor 310 may be cancelled by an opposite nulling wave generated proximate the receiver 105. The transmitter 110 and/or receivers 105 may be powered by a downhole turbine 303, battery 304 or power transmission system 305.

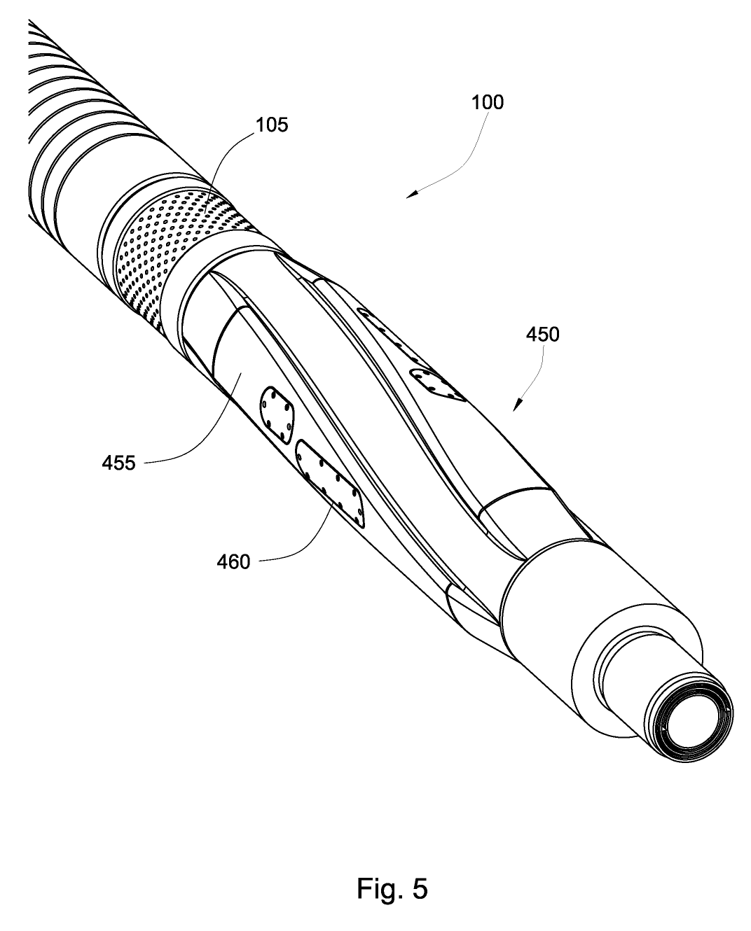

FIG. 5 is a perspective diagram of an embodiment of a tool string component 100. In some embodiments the tool string component 100 may comprise receivers 105 mounted to the tool string component 100. Such receivers 105 may be adapted to detect and measure vibrations or other waves propagating to the tool string component 100. Receivers 105 may comprise geophones, hydrophones, or accelerometers.

In some embodiments, the tool string component 100 may comprise a stabilizer 450. The stabilizer 450 may comprise a plurality of stabilizer blades 455 that may further comprise pockets 460 adapted to hold a receiver 105 or plurality of receivers 105. When the tool string component 100 is disposed in a borehole, at least one stabilizer blade 455 may extend to contact the formation which may allow better coupling of receivers 105 to the borehole.

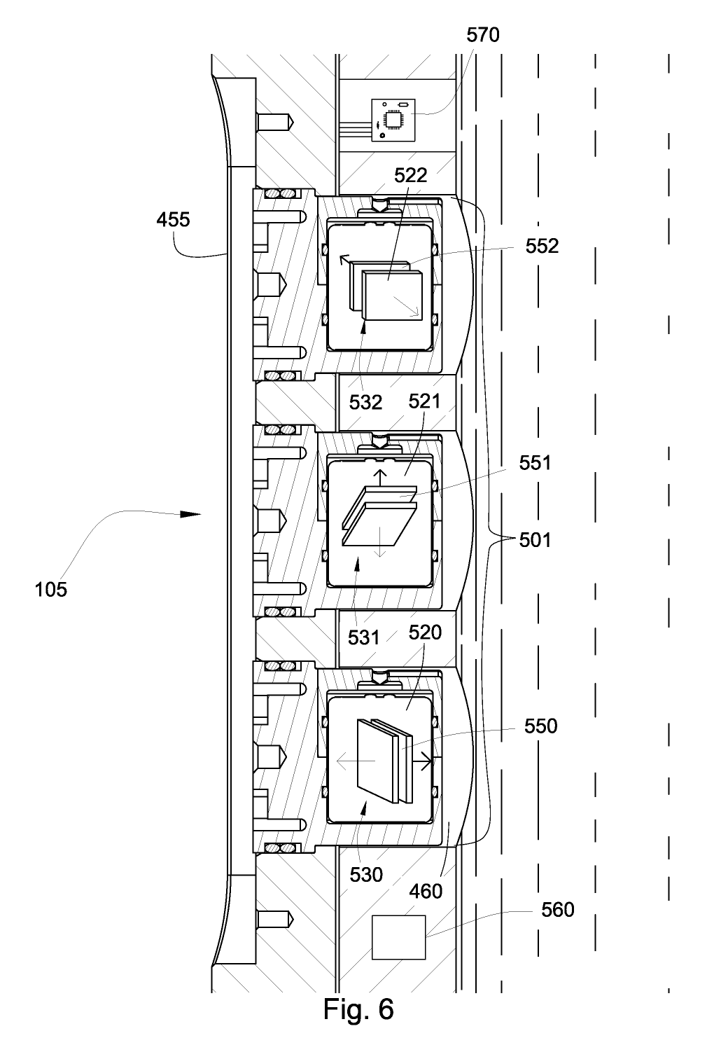

FIG. 6 is a cross-sectional diagram of an embodiment of a receiver 105 integrated into a stabilizer blade 455. The receiver 105 may be a three-component geophone 501. The stabilizer blade 455 may have a pocket 460 adapted to receive at least three downhole geophones wherein each geophone 520, 521, 522 receives signals on different orthogonal axes. The first geophone 520 may be adapted to receive and measure signals in the y-direction 530 with respect to a three-dimensional coordinate system, the second geophone 521 may be adapted to receive and measure signals in the z-direction 531 with respect to a three-dimensional coordinate system, and the third geophone 522 may be adapted to receive and measure signals in the x-direction 532 with respect to a three-dimensional coordinate system.

The stabilizer blade 455 may also comprise at least three piezoelectric transducers wherein each piezoelectric transducer 550, 551, 552 correlates with a respective geophone 520, 521, 522. Each piezoelectric transducer 550, 551, 552 may produce a nulling wave on a different orthogonal axis. The first piezoelectric transducer 550 may be adapted to produce a nulling wave in the y-direction 530 with respect to a three-dimensional coordinate system, the second piezoelectric transducer 551 may be adapted to produce a nulling wave in the z-direction 531 with respect to a three-dimensional coordinate system, and the third piezoelectric transducer 552 may be adapted to produce a nulling wave in the x-direction 532 with respect to a three-dimensional coordinate system.

In some embodiments, each piezoelectric transducer 550, 551, 552 may be individually driven by a canceling signal generator 570 to cancel the effects of a tube wave traveling along the length of the borehole or an acoustic wave traveling along the length of the tool string. The canceling signal generator 570 may be in communication with surface equipment 103 (see FIG. 1) comprising a primary signal generator. The primary signal generator may send a signal to be transmitted in the form of an acoustic wave by the transmitter 110 (see FIG. 1). The surface equipment 103 may also comprise a comparator. The comparator may read the signal generated by the primary signal generator and lock into that signal. The comparator may then communicate to the canceling signal generator 570 which signals need to be transmitted through the piezoelectric transducers 550, 551, 552 to attempt to cancel unwanted signals. When actively driven by a canceling signal generator 570 the piezoelectric transducers 550, 551, 552 may have a nulling effect on the geophones 520, 521, 522. The primary signal generator and comparator may also be kept downhole.

In some embodiments, the canceling signal generator 570 may be connected to at least one piezoelectric sensor 560. The piezoelectric sensor 560 may read tube waves traveling along the borehole or acoustic waves traveling along the length of the tool string. The piezoelectric sensor 560 may then communicate to the canceling signal generator 570 what signals need to be transmitted through the piezoelectric transducers 550, 551, 552 to attempt to cancel those signals.

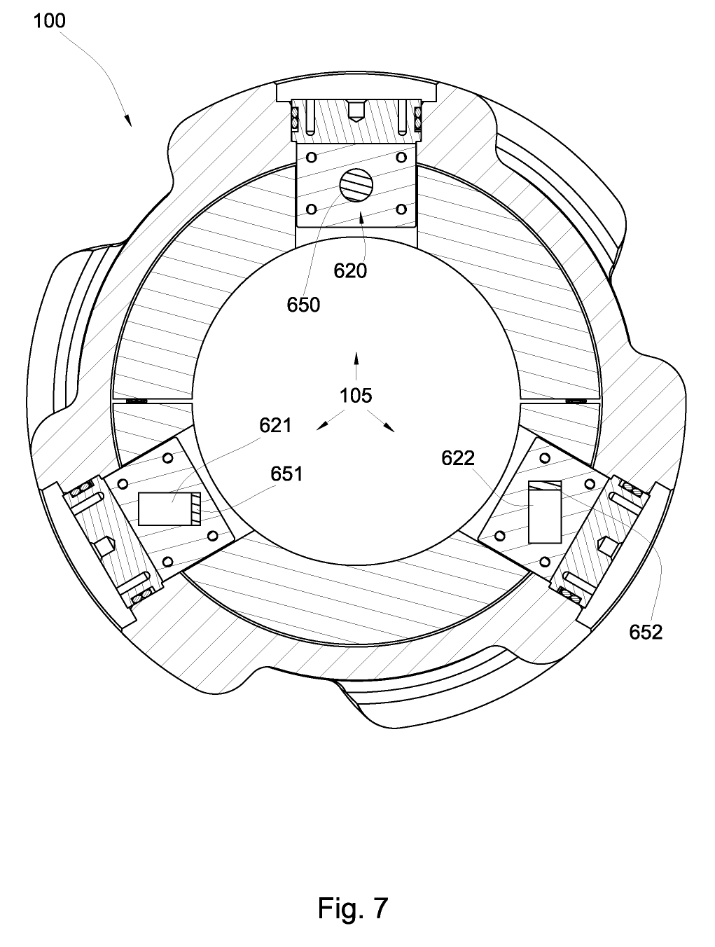

FIG. 7 is an axial cross-sectional diagram of an embodiment of a receiver 105 integrated into a tool sting component 100. In this embodiment, the receiver 105 comprises three geophones 620, 621, 622 each on different orthogonal axes with respect to a three-dimensional coordinate system. In this embodiment, the receiver 105 also comprises three piezoelectric transducers 650, 651, 652 which each correlate with a respective geophone 620, 621, 622. Each piezoelectric transducer 650, 651, 652 may produce a nulling wave on a different orthogonal axis.

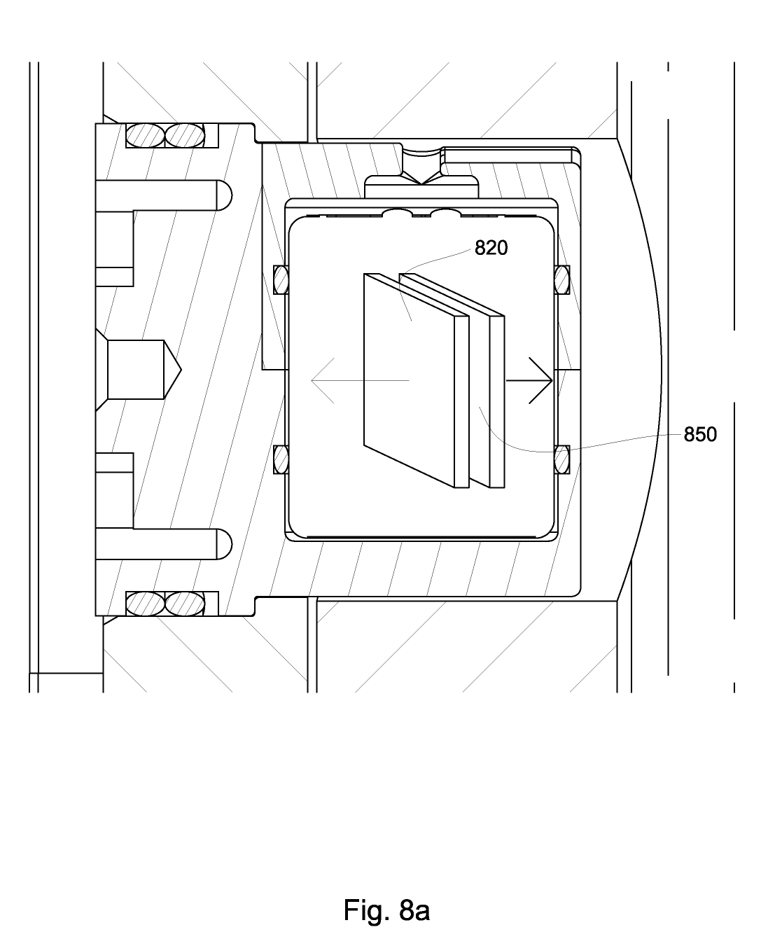

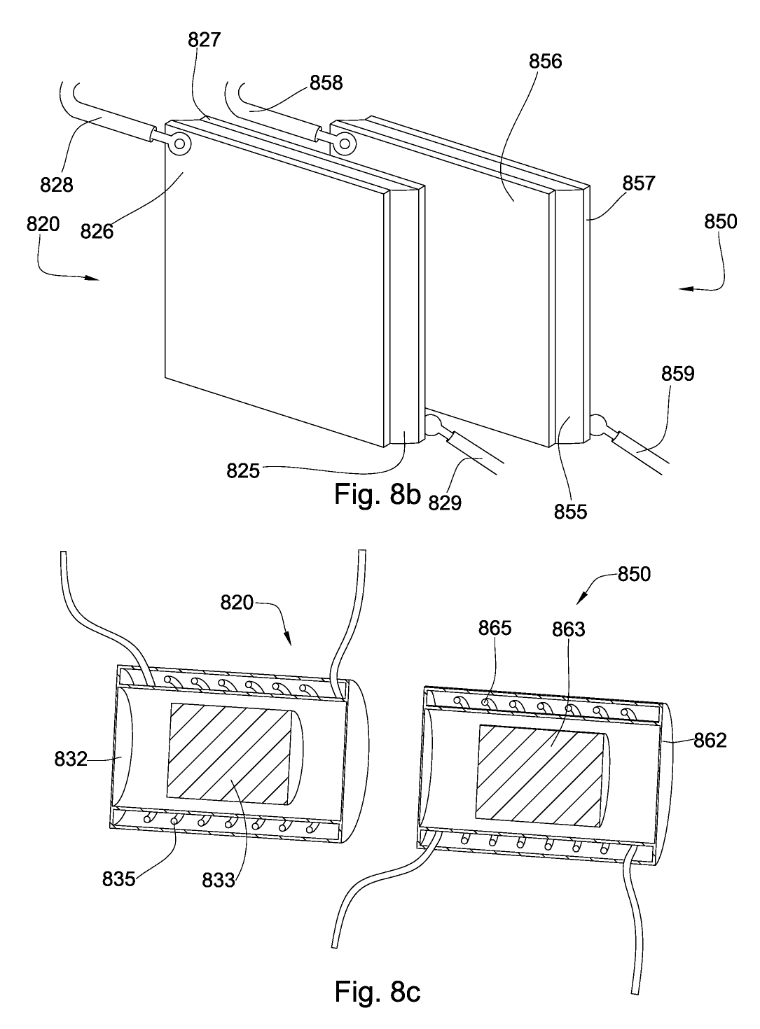

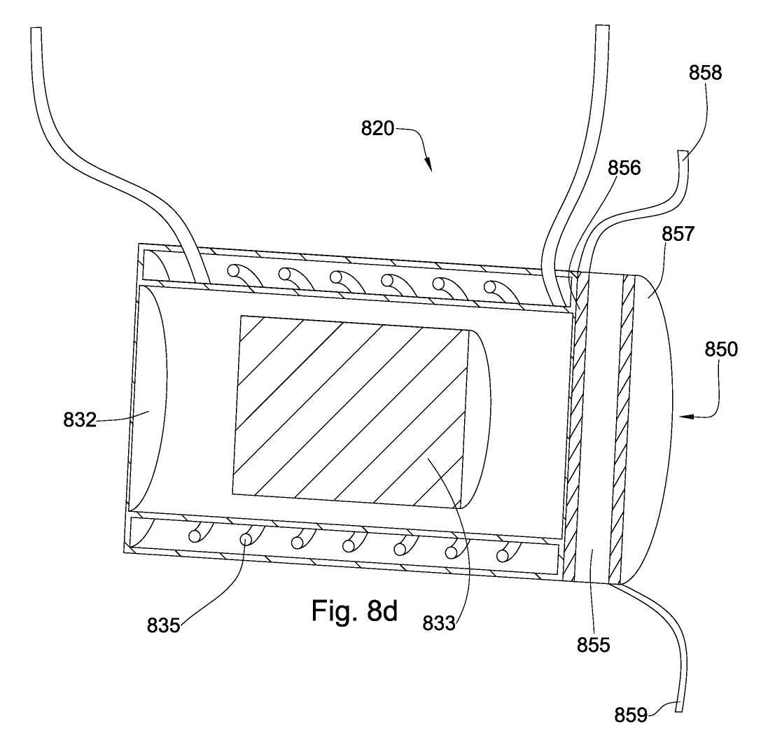

FIG. 8a shows a close-up view of embodiments of a receiver 820 and transducer 850. The receiver 820 may be adapted to receive and measure acoustic waves. The transducer 850 may be adapted to produce a nulling acoustic wave to substantially cancel unwanted acoustic waves at the receiver 820.

FIG. 8b depicts other embodiments of the receiver 820 and transducer 850. The embodiment of the receiver 820 shown comprises a piezoelectric crystal 825 intermediate two conductive plates 826 and 827. The two conductive plates 826 and 827 are wired to a measuring device (not shown) by two wires 828 and 829 respectively. As pressure is applied to the two conductive plates 826 and 827 in the form of an acoustic wave an electrical current is generated in the piezoelectric crystal 825. That electrical current may be sent into the two wires 828 and 829 and may further be measured by the measuring device. The embodiment of the transducer 850 shown also comprises a piezoelectric crystal 855 intermediate two conductive plates 856 and 857. The two conductive plates 856 and 857 are wired to a canceling signal generator (not shown) by two wires 858 and 859 respectively. The canceling signal generator may send an electrical current into the two wires 858 and 859 and thus cause the piezoelectric crystal 855 to expand and contract. This expansion and contraction may produce a nulling acoustic wave to substantially cancel unwanted acoustic waves at the receiver 820.

FIG. 8c depicts a cross-sectional view of other embodiments of the receiver 820 and transducer 850. In the embodiments shown, the receiver 820 may comprise a frame 832 housing a coil of wire 835 that may be connected to a measuring device (not shown). A magnet 833 may be housed within the coil of wire 835. As a wave hits the frame 832, the magnet 833 may oscillate within the coil of wire 835 thus causing an electrical current to form within the coil of wire 835. That electrical current may be measured by the measuring device. The embodiment of the transducer 850 shown may also comprise a frame 862. The frame 862 may house a coil of wire 865 that may be connected to a canceling signal generator (not shown). A magnet 863 may be housed within the coil of wire 865. The canceling signal generator may send an electrical current into the coil of wire 865 and thus cause the magnet 863 to oscillate within the coil of wire 865. This oscillation of the magnet 863 may produce a nulling wave to substantially cancel unwanted waves at the receiver 820.

FIG. 8d depicts a cross-sectional view of other embodiments of the receiver 820 and transducer 850. In the embodiments shown, the receiver 820 may comprise a frame 832 housing a coil of wire 835 that may be connected to a measuring device (not shown). A magnet 833 may be housed within the coil of wire 835. As a wave hits the frame 832, the magnet 833 may oscillate within the coil of wire 835 thus causing an electrical current to form within the coil of wire 835. That electrical current may be measured by the measuring device. The embodiment of the transducer 850 shown may comprise a piezoelectric crystal 855 intermediate two conductive plates 856 and 857. The two conductive plates 856 and 857 are wired to a canceling signal generator (not shown) by two wires 858 and 859 respectively. The canceling signal generator may send an electrical current into the two wires 858 and 859 and thus cause the piezoelectric crystal 855 to expand and contract. This expansion and contraction may produce a nulling acoustic wave to substantially cancel unwanted acoustic waves at the receiver 820.

Whereas the present invention has been described in particular relation to the drawings attached hereto, it should be understood that other and further modifications apart from those shown or suggested herein, may be made within the scope and spirit of the present invention.

What is claimed is:

1. A downhole tool string assembly, comprising:
an acoustic transmitter attached to a primary signal generator;
at least one acoustic receiver disposed on a tool string and attached to a measuring device; and
at least one acoustic transducer disposed on the tool string and attached to a canceling signal generator.

2. The assembly of claim 1, wherein the at least one acoustic transducer comprises a piezoelectric crystal or electromagnetic coil.

3. The assembly of claim 1, wherein the at least one transducer is spaced apart from the transmitter and proximate the at least one receiver.

4. The assembly of claim 1, further comprising at least one acoustic sensor disposed on the tool string and spaced apart from the at least one receiver.

5. The assembly of claim 4, further comprising a plurality of acoustic sensors disposed on the tool string and spaced at varying distances from the at least one receiver.

6. The assembly of claim 4, wherein the canceling signal generator is in communication with the at least one acoustic sensor.

7. The assembly of claim 4, wherein the receiver is disposed intermediate at least two acoustic sensors.

8. The assembly of claim 1, wherein the canceling signal generator is in communication with a comparator which is in communication with the primary signal generator.

9. The assembly of claim 1, wherein the canceling signal generator is in communication with a downhole telemetry network comprising inductive couplers located in joints of the tool string.

10. The assembly of claim 1, wherein the transmitter comprises, a hammer, an explosive element, seismic source, a siren, a jar, a piezoelectric source, a magnetostrictive element, an eccentric rotor, or a drill bit.

11. The assembly of claim 1, wherein the at least one receiver comprises, a geophone, a hydrophone, or an accelerometer.

12. The assembly of claim 1, wherein the transmitter produces a characteristic wave such that the characteristic wave may be differentiated from noise generated by the tool string.

13. The assembly of claim 1, further comprising a plurality of acoustic receivers oriented orthogonal one another and circumferentially around the tool string.

14. The assembly of claim 15, wherein the plurality of acoustic receivers is substantially evenly spaced along the tool string.

15. The assembly of claim 1, wherein the transmitter is disposed on the same tool string as the receiver.

16. The assembly of claim 1, wherein the transmitter is disposed on a separate tool string from the receiver.

17. The assembly of claim 1, wherein the transmitter is disposed on the surface of an earthen formation.

18. The assembly of claim 1, wherein the transducer is powered by a downhole battery, turbine, a power transmission system or combinations thereof.

19. A method of obtaining information about an earthen formation, comprising:
providing an acoustic transmitter, at least one acoustic receiver disposed on a tool string, at least one acoustic sensor disposed on the tool string and spaced apart from the at least one receiver, and at least one acoustic transducer disposed on the tool string;
transmitting a primary wave into an earthen formation with the acoustic transmitter;
measuring an unwanted wave traveling along the tool string with the acoustic sensor;
creating a canceling wave with the acoustic transducer proximate the acoustic receiver to cancel the affects of the unwanted wave; and
measuring the primary wave with the acoustic receiver.

20. A method of obtaining information about an earthen formation, comprising:
providing an acoustic transmitter, at least one acoustic receiver disposed on a tool string, and at least one acoustic transducer disposed on the tool string;
transmitting a primary wave into an earthen formation with the acoustic transmitter;
locking into the primary wave transmitted by the acoustic transmitter;
creating a canceling wave with the acoustic transducer proximate the acoustic receiver to cancel the affects of unwanted waves; and
measuring the primary wave with the acoustic receiver.
